(19) United States
(12) Patent Application Publication
(10) Pub. No.: US 2007/0070991 A1
(43) Pub. Date: Mar. 29, 2007

(54) Method and apparatus for voice over IP telephone

(76) Inventors: Masatomo Tokuno, Tokyo (JP); Kuniyasu Kiyono, Tokyo (JP); Masahiro Handa, Tokyo (JP); Masanori Inui, Tokyo (JP)

Correspondence Address: REED SMITH LLP, 3110 FAIRVIEW PARK DRIVE, SUITE 1400, FALLS CHURCH, VA, 22042, US

(21) Appl. No.: 11/472,269

(22) Filed: Jun. 22, 2006

(30) Foreign Application Priority Data
Jun. 23, 2005 (JP) 2005-182723

(51) Int. Cl. H04L 12/66

(52) U.S. Cl. 370/356

(57) ABSTRACT

To realize various additional service functions, which are available in a main device of a conventional button telephone system, in a voice over IP telephone. [Solving Means]

A voice over IP telephone apparatus for carrying out voice communication adapted to an Internet Protocol (IP) through Internet is made to include a transmission/additional information generating and analyzing unit 12 for generating, at a transmitting side, additional information of service content to be added to transmission information related to a transmitter and a receiver as a destination, and for analyzing, at a receiving side, the additional information added to the transmission information transmitted by the transmitter to obtain the service content. The transmission/additional information generating and analyzing unit 12 is configured to check a response type for receiving, check a specified receiving communication type, and, when transmitting, generate transmission information specifying a response type at a receiving end and a communication type.

### TECHNICAL FIELD

The present invention relates to a method and apparatus for voice over IP telephone by the Internet Protocol (IP). More specifically, the present invention is to provide a new telephone method and apparatus for realizing additional service functions, which are included in a main device of a conventional button telephone system, in a voice over IP telephone adapted to the Internet Protocol (IP).

### Prior Art

In a button telephone system where a conventional main device is used, the main device integrally controls telephone terminals and peripheral equipments contained therein. The main device includes its own interface and integrally and continuously manages the operation status, such as a channel determination, a display and a lamp control, regarding call control of the telephone terminals and peripheral equipments contained in the main device. Accordingly, additional services such as a paging (local area broadcasting) service, a voice call service, and a voice mail (conversation recording) service can be achieved easily. However, since the main device does not manage devices which are not contained therein, such additional services cannot be realized in those devices.

On the other hand, in a voice over IP telephone where devices are connected to each other in an IP network, a call control is carried out by using various protocols and control of each device is separately carried out in each device. Accordingly, there has been a problem that additional service functions that are available in the main device of a conventional button telephone system cannot be achieved in the voice over IP telephone.

Patent Document 1 discloses the following means (abstract) A plurality of telephone terminals adapted to the Internet Protocol are connected to a LAN network so as to form an IP network. For each minimum constituent unit in the IP network, an SIP server function by protocols for controlling starting, ending, and changing in a session of interactive communication, a resource control server function for controlling, storing, and delivering terminal status database of the plurality of telephone terminals, and an application server function for providing necessary service to the plurality of telephone terminals are connected to the LAN network as control functions of the plurality of telephone terminals so that information transmissions among the server functions are carried out on packet basis.

With such a structure, the invention of Patent Document 1 solves the problem as follows. The invention provides a telephone communication system for effectively carrying out an exchange of telephone information among terminals with a simple structure and for dealing with an increase or a decrease in the number of containing terminals with high flexibility.

However, according to the invention of Patent Document 1, there has been a problem that additional service functions cannot be provided easily since each terminal is required to operate only for each additional service function in order to perform various kinds of additional service functions such as selection of normal response or automatic response, selection of one-way communication or two-way communication when answering a call, paging (local area broadcasting), voice call, voice mail (conversation recording), and door phone function. Further, there has been another problem that it is not easy to provide services adapted to preferences of each user since a server function is needed to be added for each additional service function in order to provide an additional service for controlling each voice over IP telephone terminal with the server or the like.

Patent Document 2 discloses the following means (paragraph 0020). The invention of Patent Document 2 is related to a voice mail system by an IP telephone terminal which operates according to the Internet Protocol (IP). An IP address name other than a conventional IP address name is registered as a silent receiving mail address to a receiving side network corresponding to a telephone terminal number in order to receive in silent mode. Then, upon a request for a connection to the silent receiving mail address from a caller, an internal memory region in a relevant destination telephone terminal is called in silent and a voice message from the caller is recorded and stored in the memory region.

With such a structure, the invention of Patent Document 2 solves the problem as follows (paragraph 0064). The caller does not need to wait the response from the receiver to transmit the voice mail. At the same time, the receiver can see the received voice mail immediately.

However, according to the invention of Patent Document 2, two mail addresses, that are a conventional IP address and a silent receiving mail address, are needed to be registered for each user. This results in an increase in cost since the number of mail addresses to be stored increases and it brings a great burden on an address server. Further, it has been cumbersome that the users have to deal with two mail addresses separately.

[Patent Document 1] Japanese Patent Application Laid-Open No. 2002-152224

[Patent Document 2] Japanese Patent Application Laid-Open No. 2003-110742

[Disclosure of the Invention]

[Problem to be Solved by the Invention]

There has been a problem that various additional service functions, which are available in a main device of a conventional button telephone system, cannot be provided easily since each terminal is required to operate only for one of additional service functions to perform the additional service functions such as selection of normal response or automatic response, selection of one-way communication or two-way communication when answering a call, paging (local area broadcasting), voice call, voice mail (conversation recording), and door phone function. Further, there has been another problem that it is not easy to provide services adapted to preferences of each user since a server function is needed to be added for each additional service function in order to provide an additional service for controlling each voice over IP telephone terminal with the server or the like. The reason for users not employing a voice over IP telephone is that various additional service functions which are available in a main device of a conventional button telephone system are not provided in the voice over IP telephone. Therefore, it has been desired that those various additional service functions are provided in the voice over IP telephone.

Conventionally, there has been a problem that a service function which is necessary for some users but not for other users is contained in each terminal and a main device and this may cause complicated operations and an increase in cost. Also, it has been desired a voice over IP telephone in which a user is not required to register a plurality of mail addresses, that is, a conventional IP address and an address corresponding to a service function when a service function is added. In such a desired system, burden of an address server becomes small, it does not cause an increase in cost, and users do not have difficulty in using a plurality of mail addresses separately.

[Means for Solving the Problem

Voice over IP telephone means for carrying out voice communication adapted to an Internet Protocol through Internet includes transmission/additional information generating and analyzing means for generating, at a transmitting side, additional information of service content to be added to transmission information related to a transmitter and a receiver as a destination, and for analyzing, at a receiving side, the additional information added to the transmission information transmitted by the transmitter to obtain the service content.

The transmission/additional information generating and analyzing means includes: transmission information generating means for generating transmission information related to the transmitter and the receiver as a destination; additional information generating means for generating additional information so as to include a response type specifying whether the receiver as a destination is requested to answer by normal response or automatic response and a communication type specifying one of one-way communication and two-way communication and be added to the transmission information; transmission information analyzing means for analyzing, at the receiving side, the transmission information transmitted by the transmitter to obtain the analyzed transmission information; and additional information analyzing means for analyzing the response type specifying whether the receiver is requested to answer by normal response or automatic response and the communication type specifying one of one-way communication and two-way communication, which are added to the analyzed transmission information, to obtain analyzed additional information.

Additional information may include various service functions such as information for a door phone function, information for recording/reproducing function, and information for a paging function. Such voice over IP telephone functions are provided to a terminal (VoIP device) and an application server.

[Effect of the Invention]

The various additional service functions, which are available in a main device of a conventional button telephone system, such as selection of normal response or automatic response, selection of one-way communication or two-way communication when answering a call, paging (local area broadcasting), voice call, voice mail (conversation recording), and door phone function can be realized without lowering the characteristics of the voice over IP telephone. Necessary functions among the voice over IP telephone functions are provided to necessary terminals (VoIP devices). Further, those functions can also be added to an application server.

Unlike conventional button telephone systems, a service function which is necessary for some users but not for others is not installed in each terminal and a main device so that the complexity in operations is eliminated. It is no longer necessary to switch terminals (VoIP devices) for each service. The terminal (VoIP device) and the application server may be basically formed in the same structure so that they employ the same algorithm. Even when various services are added, the burden on an entire system is very small. Therefore, reduction in manufacturing time and reduction in cost are achieved. Since services can be added without changing user's original mail address or adding a new mail address, there is no extra burden on users.

[Best Mode for Carrying Out the Invention]

The present invention is made as a voice over IP telephone apparatus including voice over IP telephone means for carrying out voice communication adapted to an Internet Protocol (IP) through Internet. The voice over IP telephone means comprises transmission/additional information generating and analyzing means for generating, at a transmitting side, additional information of service content to be added to transmission information related to a transmitter and a receiver as a destination, and for analyzing, at a receiving side, the additional information added to the transmission information transmitted by the transmitter to obtain the service content.

The transmission/additional information generating and analyzing means is configured to include transmission information generating means for generating transmission information related to the transmitter and the receiver as a destination; additional information generating means for generating additional information so as to include a response type specifying whether the receiver as a destination is requested to answer by normal response or automatic response and a communication type specifying one of one-way communication and two-way communication and be added to the transmission information; transmission information analyzing means for, at the receiving side, analyzing the transmission information transmitted by the transmitter to obtain the analyzed transmission information; and additional information analyzing means for analyzing the response type specifying whether the receiver is requested to answer by normal response or automatic response and the communication type specifying one of one-way communication and two-way communication, which are added to the analyzed transmission information, to obtain analyzed additional information.

Additional information may include various service functions such as information for a door phone function, information for a recording/reproducing function, and information for a paging function. Such voice over IP telephone functions are provided to a terminal (VoIP device) and an application server.

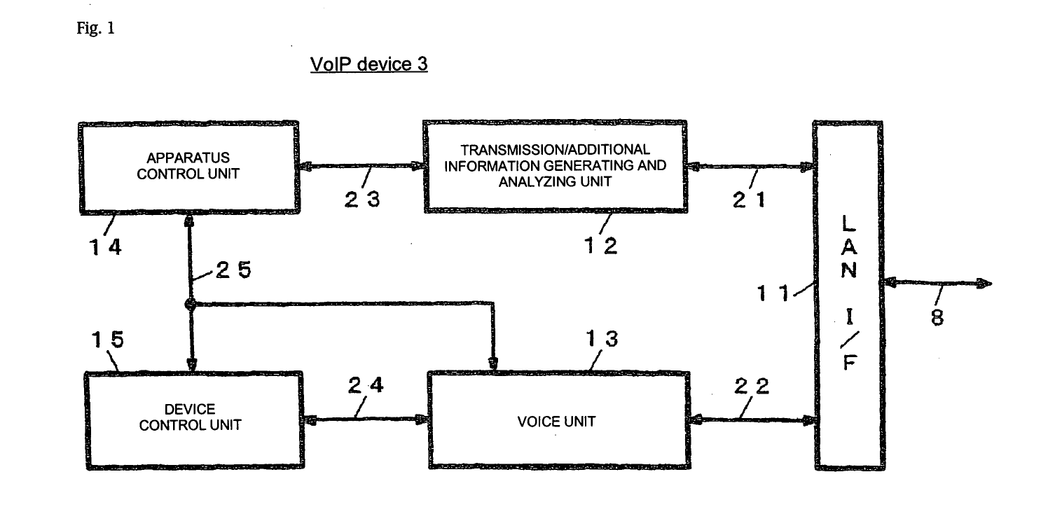

FIG. 1 is a functional block diagram showing a function of one embodiment according to the present invention. A VoIP (Voice over Internet Protocol) device 3 as a terminal of a voice over IP telephone by the Internet Protocol (IP) is connected to an IP network via a LAN (Local Area Network) or directly by a channel 8. The VoIP device 3 uses a Voice over IP protocol. As such a Voice over IP protocol, for example, there are SIP (Session Initiation Protocol) and H.323 which is stipulated in relation to the SIP. The channel 8 communicates with a transmission/additional information generating and analyzing unit 12 by an information signal 21 and with a voice unit 13 by a voice code signal 22 via a LAN interface (I/F) 11.

The apparatus control unit 14 communicates with the transmission/additional information generating and analyzing unit 12 by an information control signal 23 and with the voice unit 13 and a device control unit 15 by a voice device control signal 25. The device control unit 15 communicates with the voice unit 13 by a voice information control signal 24. The device control unit 15 controls a handset, a head set, a speaker and the like in addition to the voice unit 13.

The transmission/additional information generating and analyzing unit 12 generates transmission information and additional information to be transmitted to a destination and analyzes transmission information and additional information which is received from the other party. The transmission/additional information generating and analyzing unit 12 analyzes the transmission information and the additional information received from the other party via the channel 8, the LAN interface (I/F) 11, and the information signal 21, directly from the IP network 1 or via the LAN, and notifies the apparatus control unit 14 by the information control signal 23. Upon an instruction from the apparatus control unit 14, the transmission/additional information generating and analyzing unit 12 generates transmission information and additional information and transmits to the other party via the information signal 21, the LAN interface (I/F) 11, the channel 8, and the IP network 1.

The apparatus control unit 14 controls calls of the VoIP device 3 and controls the transmission/additional information generating and analyzing unit 12, the voice unit 13, and the device control unit 15. The device control unit 15 controls a memory device such as a hard disk, a handset, a head set, a speaker, a microphone and the like. The voice unit 13 includes codec to encode or decode voices by RTP (Realtime Transport Protocol) transformation or inverse transformation.

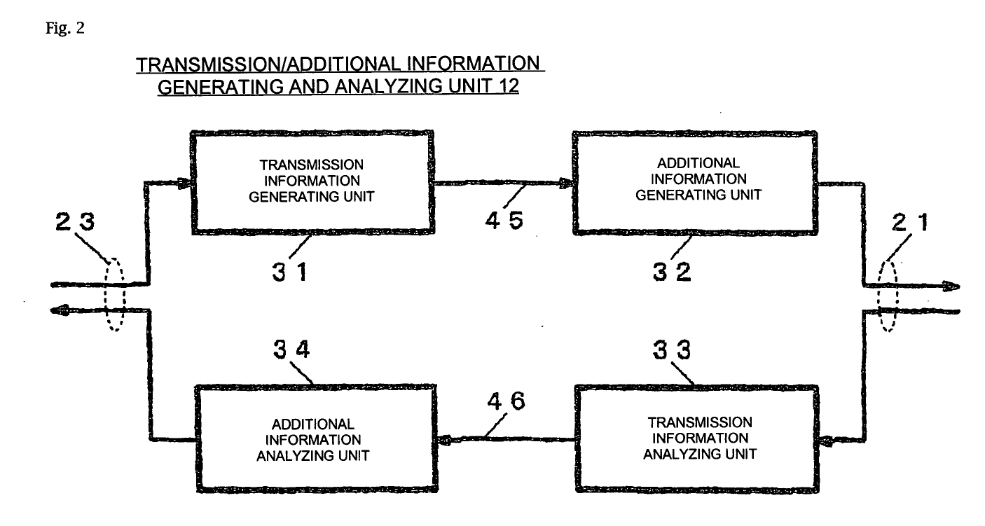

FIG. 2 is a functional block diagram showing internal details of the transmission/additional information generating and analyzing unit 12 which is an important constituent element in FIG. 1. The transmission/additional information generating and analyzing unit 12 includes a transmission information generating unit 31, an additional information generating unit 32, a transmission information analyzing unit 33, and an additional information analyzing unit 34. Upon receiving the information control signal 23, the transmission information generating unit 31 generates transmission information including own address and destination address and outputs the information as a transmission information generating signal 45. The additional information generating unit 32 generates additional information which instructs, at the destination end, whether the response type is normal response or automatic response, whether the communication type is two-way communication or one-way communication, and whether the one-way communication is for transmitting side only or receiving side only. The additional information generating unit 32 transmits the additional information as the information signal 21. Here, the transmission information generating unit 31 and the transmission information analyzing unit 33 are the same as those used in conventional art.

When receiving the information signal 21, the transmission information analyzing unit 33 analyzes the transmission information and provides the additional information analyzing unit 34 with a transmission information analyzing signal 46 containing the additional information. The additional information analyzing unit 34 analyzes the contained additional information and analyzes whether the response type is normal response or automatic response, whether the communication type is two-way communication or one-way communication, and whether the one-way communication is for transmitting side only or receiving side only. Then the additional information analyzing unit 34 outputs it as the information control signal 23.

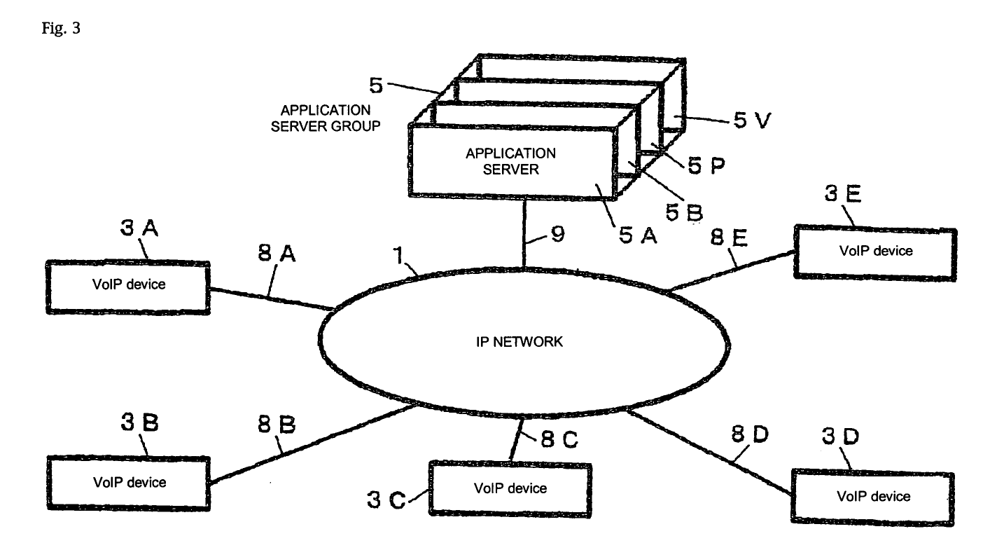

FIG. 3 is a conceptual diagram showing a connection when the present invention is applied to an IP network adapted to the Internet Protocol (IP). In the IP network 1, VoIP devices 3A, 3B, 3C, 3D, 3E and an application server group 5 including many application servers 5A, 5B, 5P, 5V are connected directly or via unshown LAN. The VoIP device 3D has, for example, a door phone function. The application server 5P has, for example, a paging function. The application server 5V has, for example, a voice mail function.

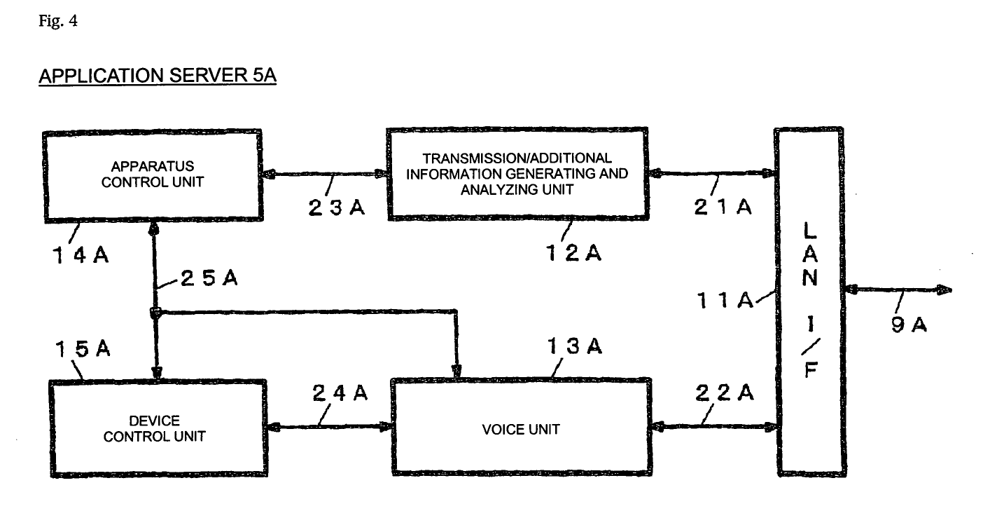

FIG. 4 is a functional block diagram showing internal details of, for example, the application server 5A. Basically, the application server 5A includes the same constituent elements as those of the VoIP device 3 shown in FIG. 1. The differences from the VoIP device 3 is that it is connected to a server channel 9A via a LAN interface (I/F) 11A and that a device control unit 15A controls a memory device such as a hard disk but not a handset, a head set, a speaker, or a microphone since the application server 5A is not required to output a sound. As for the rest of the above, the application server 5A operates in the same way as the VoIP device 3 does.

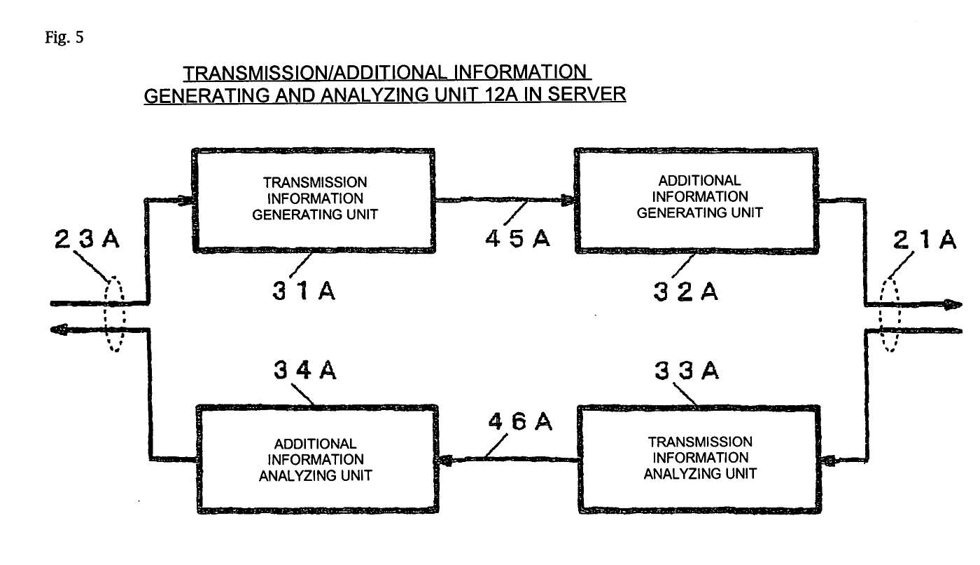

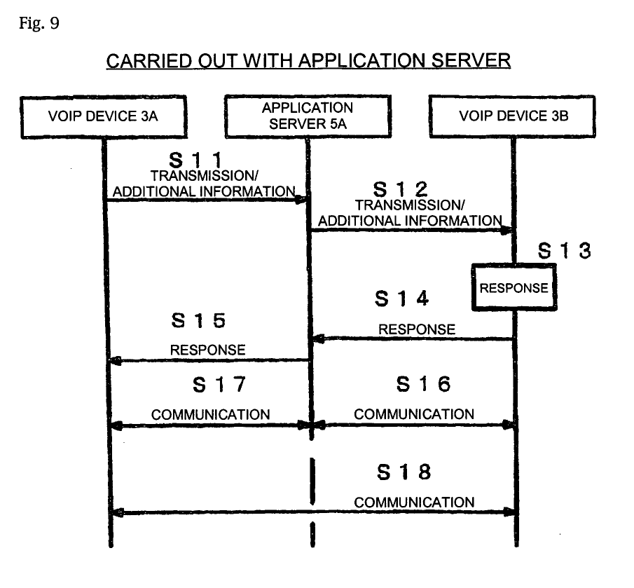

FIG. 5 is a functional block diagram showing internal details of a transmission/additional information generating and analyzing unit 12A included in the application server 5A. The transmission/additional information generating and analyzing unit 12A has the same constituent elements as those of the transmission/additional information generating and analyzing unit 12 of the VoIP device 3 shown in FIG. 2. The difference from the transmission/additional information generating and analyzing unit 12 of the VoIP device 3 is that when the VoIP device 3A and the VoIP device 3B communicate, the application server 5A, for example, relays transmission information and additional information between the VoIP device 3A and the VoIP device 3B in advance. Another difference is that during the communication between the VoIP device 3A and the VoIP device 3B, a communication relay unit (not shown) realizes the relay between the VoIP device 3A and the VoIP device 3B (See FIG. 9 and its explanation which will be described later). As for the rest of the above, each constituent element of the transmission/additional information generating and analyzing unit 12A of the application server 5A operates in the same way as each constituent element of the transmission/additional information generating and analyzing unit 12 of the VoIP device 3.

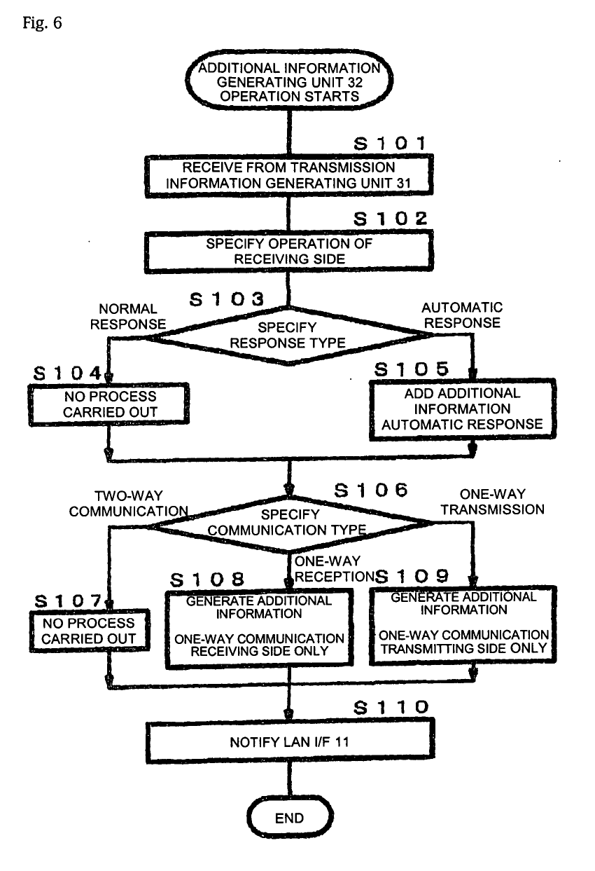

FIG. 6 is a flowchart showing operations of the additional information generating unit 32 (or 32A). When the additional information generating unit 32 (or 32A) starts to operate, it receives the transmission information generating signal 45 (or 45A) from the transmission information generating unit 31 (or 31A) (S101) and specifies an operation of a receiver as a destination (S102). The additional information generating unit 32 (or 32A) specifies a response type whether it is required to operate a normal response or an automatic response (S103). When a normal response is specified (S103, normal response), the process goes to step S106 without a response type specifying process (S104). When an automatic response is specified (S103, automatic response), it adds additional information so that the destination receiver performs an automatic response (S105).

Then, a communication type is specified whether it is required to operate two-way communication or one-way communication and whether the one-way communication is for receiving side only or transmitting side only (S106). When two-way communication is specified (S106, two-way communication), it does not operate a communication type specifying process (S107), and the process goes to step S110. When the one-way communication is for receiving side only (S106, one-way reception), one-way communication for receiving side only is specified (S108), and then, the process goes to step S110. When the one-way communication is for transmitting side only (S106, one-way transmission), one-way communication for transmitting side only is specified (S109). Then, the additional information generating unit 32 (or 32A) notifies the LAN interface (I/F) 11 (or 11A), and the operation of the additional information generating unit 32 (or 32A) is completed (S110).

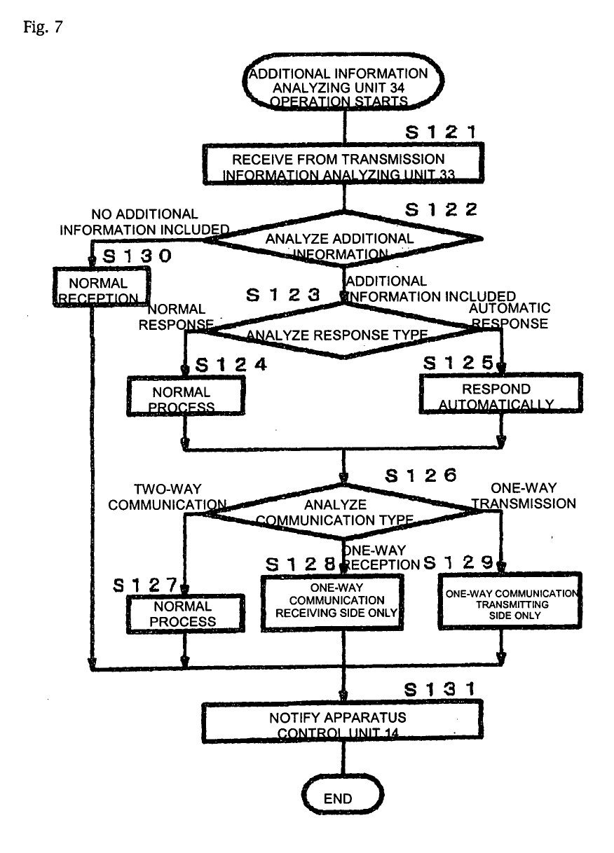

FIG. 7 is a flowchart showing operations of the additional information analyzing unit 34 (or 34A). When the additional information analyzing unit 34 (or 34A) starts to operate, it receives the transmission information analyzing signal 46 (or 46A) from the transmission information analyzing unit 33 (or 33A) (S121) Then, it starts to analyze the additional information contained in the transmission information analyzing signal 46 (or 46A) (S122) When additional information is included (S122, additional information included), it analyzes its response type (S123). When the response type specifies a normal response (S123, normal response), it operates a normal process (S124) and the process goes to step S126. When the response type specifies an automatic response (S123, automatic response), it operates automatic response process (S125), and starts to analyze its communication type (S126).

When the communication type specifies two-way communication (S126, two-way communication), it operates a normal process (S127) and the process goes to step S131. When the communication type instructs one-way communication for receiving side only (S128, one-way reception), it operates one-way communication for receiving side only (S128), and the process gores to step S131. When the communication type specifies a one-way communication for transmitting side only (S128 one-way transmission), it operates one-way communication for transmitting side only (S129). Then the additional information analyzing unit 34 (or 34A) notifies the apparatus control unit 14 (or 14A) and completes the additional information analyzing process (S131). When the additional information analyzing unit 34 (or 34A) analyzes that no additional information is included in step S122 (S122, no additional information included), it notifies the apparatus control unit 14 (or 14A) as a normal receiving (S130) and completes the additional information analyzing process (S131).

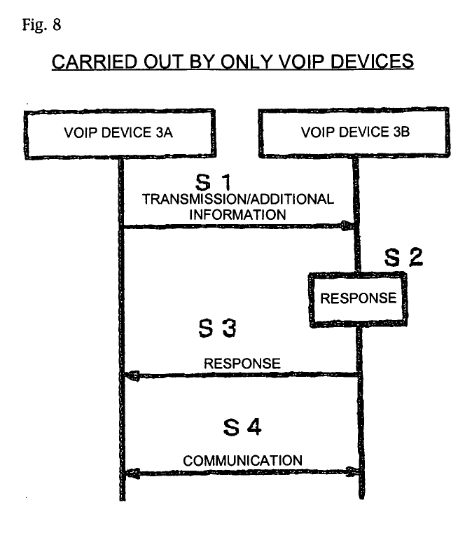

FIG. 8 is an operational transition diagram showing transition (sequence) of operations when conversation is carried out between only two VoIP devices 3A and 3B. The VoIP device 3A adds additional information specifying normal response and two-way communication to transmission information to transmit (S1). Upon receiving this, the VoIP device 3B determines automatic response or normal response according to a response type and, for example, detects that the call requests a normal response. At the same time, the VoIP device 3B determines its communication method whether it is one-way communication or two-way communication and detects that the call requests two-way communication (S2). When the additional information specifying normal response and two-way communication is read, the VoIP device 3B responses to this (S3) and communication between the VoIP devices 3A and 3B starts via IP network 1 or LAN (S4).

FIG. 9 is an operational transition diagram showing transition of operations when conversation is carried out between the two VoIP devices 3A and 3B via the application server 5A. The VoIP device 3A generates transmission information including addresses of the VoIP device 3B as a destination and the application server 5A as a relay, generates additional information including a response type specifying automatic response or normal response and a communication type specifying one-way communication or two-way communication, and then, transmits them to the application server 5A (S11). The application server 5A adds the additional information received from the VoIP device 3A and transmits to the VoIP device 3B (S12).

Upon receiving this, the VoIP device 3B determines, for example, a normal response according to the response type and two-way communication according to the communication type and response to the application server 5A based on the determination results (S14). The application server 5A relays the response to the VoIP device 3A (S15). Then, conversation between the VoIP device 3A and the VoIP device 3B starts by the relay of the application server 5A (S16, S17). Or, when, in sequence S11, the transmission information of the VoIP device 3A is set to specify that the conversation between the VoIP device 3A and the VoIP device 3B are carried out directly without the relay of the application server 5A, the conversation may be carried out directly (S18).

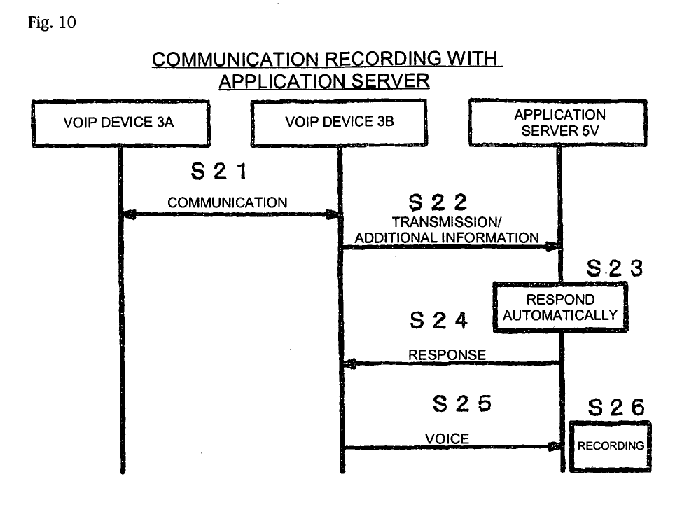

FIG. 10 is an operational transition diagram showing transition of operations when communication between the two VoIP devices 3A and AB is recorded on the application server 5V having a voice mail function. A communication is carried out between the VoIP device 3A and the VoIP device 3B (S21). During the communication or at the beginning of the communication, the VoIP device 3B instructs, as transmission information including an address of the application server 5V having a voice mail function, to record the communication according to the additional information (S22). In case of this instruction for recording communication by the additional information, automatic response by the application server 5V and one-way communication from the VoIP device 3B are selected.

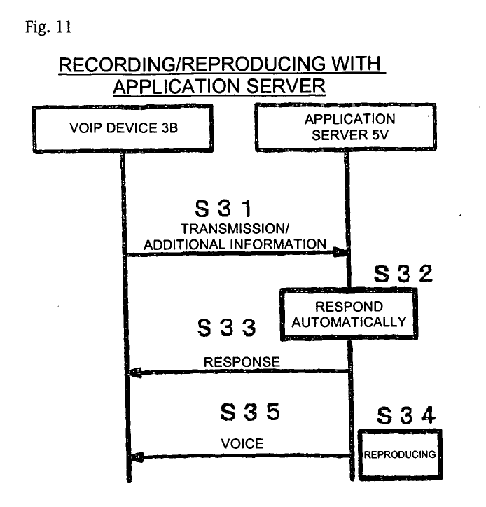

Upon receiving this instruction, the application server 5V checks the content of the instruction (S23), and transmits a response indicating that the communication recording is available to the VoIP device 3B (S24). When receiving the response from the application server 5V, the VoIP device 3B transmits voice of the communication to the application server 5V (S25), and the communication recording is carried out in the application server 5V (S26). FIG. 11 is an operational transition diagram showing transition of operations when the VoIP device 3B reproduces a record in the voice mail application server 5V having a voice mail function. The voice mail application server 5V is configured to record communication (answering machine) and store the record as voice data if necessary. The VoIP device 3B adds additional information to transmission information indicating destination address and transmits them to the voice mail application server 5V (S31). The additional information instructs for one-way communication from the voice mail application server 5V with voice mail by automatic response.

When receiving the transmission information having the additional information from the VoIP device 3B (S31), the voice mail application server 5V selects automatic response and one-way communication from the voice mail application server 5V from the additional information (S32). Then, the voice mail application server 5V responds it to the VoIP device 3B (S33) and, at the same time, reproduces the record (S34) to transmit the reproduced voice to the VoIP device 3B (S35).

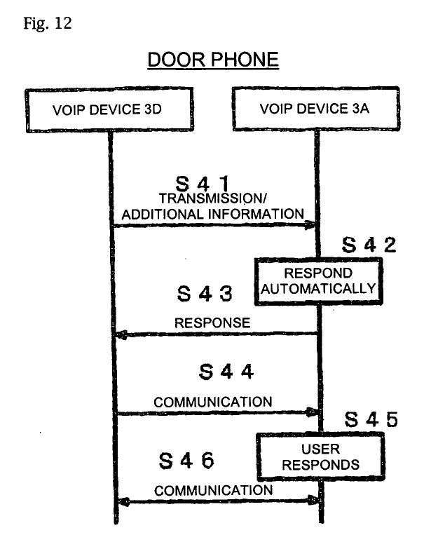

FIG. 12 is an operational transition diagram showing transition of operations when communication is carried out between the VoIP device 3A and a door phone VoIP device 3D having a door phone function. When a button of the door phone composed of a handset and a button of the door phone VoIP device 3D, which are not shown in FIG. 1, is pressed, the door phone VoIP device 3D transmits transmission information having additional information to the VoIP device 3A (S41). The additional information instructs one-way communication starting with an automatic response and two-way communication after the user answers.

Upon receiving the transmission information from the door phone VoIP device 3D, the VoIP device 3A checks the additional information (one-way communication starting with an automatic response and two-way communication after the user answers) (S42) The VoIP device 3A then automatically answers and transmits a response that allows one-way communication from the door phone VoIP device 3D to the door phone VoIP device 3D (S43). Then, communication is allowed from the door phone of the door phone VoIP device 3D (S44). When the user of the VoIP device 3A responds to this communication, it changes into two-way communication and communication between the VoIP device 3 and the door phone of the door phone VoIP device 3D is carried out (S46).

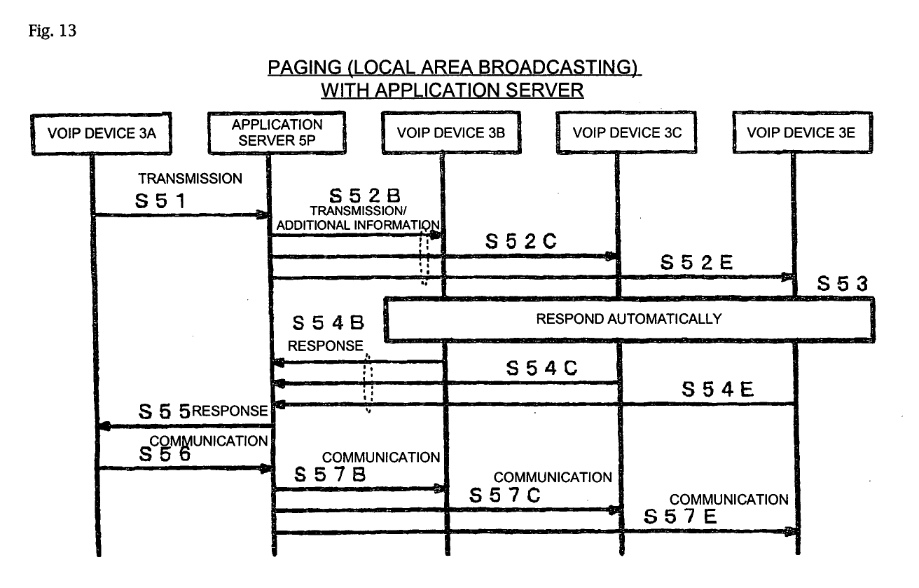

FIG. 13 is an operational transition diagram showing a transition of operations when local area broadcasting is performed from the VoIP device 3A to a number of VoIP devices 3B, 3C, 3E via a paging application server 5P having a paging function. The VoIP device 3A adds additional information specifying paging as local area broadcasting or simultaneous broadcasting to transmission information specifying an address of the paging application server 5P and transmits them to the paging application server 5P (S51).

In the paging application server 5P, destination addresses (3B, 3C, 3E) for paging and additional information (automatic response, one-way communication) to be transmitted to the destination addresses are registered in advance. When receiving a request for paging, the paging application server 5P transmits the destination addresses (3B, 3C, 3E) as the transmission information and instructions for automatic response and one-way communication as the additional information (S52B, S52C, S52E).

When receiving the instruction from the paging application server 5P, the VoIP devices 3B, 3C, 3E check the additional information (automatic response, one-way communication) (S53), and answer automatically to respond to the paging application server 5P (S54B, S54C, S54E). Then, the paging application server 5P allows communication from the VoIP device 3A when the VoIP devices 3B, 3C, 3E become ready to communicate (S55).

As the communication (broadcast) from the VoIP device 3A starts (S56), the paging application server 5P simultaneously transmits (forking) communication to the VoIP devices 3B, 3C, 3E (S57B, S57C, S57E). As clearly seen in the operations in the steps S57B, S57C, S57E, each step represents one-to-one (peer-to-peer) communication between the paging application server 5P and each of the VoIP devices 3B, 3C, 3E.

It will be appreciated that the numbers and types of the VoIP device 3 and the application server 5 are not limited to the above described embodiment and the system can be implemented with modifications according to the purposes and the scale.

### BRIEF DESCRIPTION OF THE DRAWINGS

[FIG. 1] is a functional block diagram showing one embodiment according to the present invention;

[FIG. 2] is a functional block diagram showing internal details of a transmission/additional information generating and analyzing unit which is an important constituent element in FIG. 1;

[FIG. 3] is a conceptual diagram showing a connection when the present invention is applied to an IP network;

[FIG. 4] is a functional block diagram showing internal details of an application server which is an important constituent element in FIG. 3;

[FIG. 5] is a functional block diagram showing internal details of an transmission/additional information generating and analyzing unit in an application server, which is an important constituent element in FIG. 4;

[FIG. 6] is a flowchart showing operations of an additional information generating unit which is an important constituent element in FIG. 2;

[FIG. 7] is a flowchart showing operations of an additional information analyzing unit which is an important constituent element in FIG. 2;

[FIG. 8] is an operational transition diagram showing transition of operations when communication is carried out between only two VoIP devices;

[FIG. 9] is an operational transition diagram showing transition of operations when communication is carried out between two VoIP devices via the application server;

[FIG. 10] is an operational transition diagram showing transition of operations when communication between the two VoIP devices is recorded on the application server having a voice mail function;

[FIG. 11] is an operational transition diagram showing transition of operations when the VoIP device reproduces a record from an application server having a voice mail function;

[FIG. 12] is an operational transition diagram showing transition of operations when communication is carried out between the VoIP device and a VoIP device having a door phone function; and

[FIG. 13] is an operational transition diagram showing a transition of operations when local area broadcasting is performed to a number of VoIP devices via an application server having a paging function.

### DESCRIPTION OF THE REFERENCE NUMERALS

1: IP network
3, 3 A, 3B, 3C, 3E: VoIP device
3D: Door phone VoIP device
5: Application server group
5A, 5B: Application server
5P: Paging application server
5V: Voice mail application server
8, 8A, 8B, 8C, 8D, 8E: Channel
9: Server channel
11, 11A: LAN interface (I/F)
12, 12A: Transmission/additional information generating and analyzing unit
13, 13A: Voice unit
14, 14A: Apparatus control unit
15, 15A: Device control unit
21, 21A: Information signal
22, 22A: Voice code signal
23, 23A: Information control signal
24, 24A: Voice information control signal
25, 25A: Voice device control signal
31, 31A: Transmission information generating unit
32, 32A: Additional information generating unit
33, 33A: Transmission information analyzing unit
34, 34A: Additional information analyzing unit
45, 45A: Transmission information generating signal
46, 46A: Transmission information analyzing signal

In the claims:

1. A method for a voice over IP telephone including a voice over IP telephone process for carrying out voice communication adapted to an Internet Protocol through Internet,
characterized in that the voice over IP telephone process comprises a transmission/additional information generating and analyzing process for generating, at a transmitting side, additional information of service content to be added to transmission information related to a transmitter and a receiver as a destination, and for analyzing, at a receiving side, the additional information added to the transmission information transmitted by the transmitter to obtain the service content.

2. The method for a voice over IP telephone according to claim 1,
characterized in that the transmission/additional information generating and analyzing process includes:
a transmission information generating process for generating transmission information related to the transmitter and the receiver as a destination;
an additional information generating process for generating additional information so as to include a response type specifying whether the receiver as a destination is requested to answer by normal response or automatic response and a communication type specifying one of one-way communication and two-way communication and be added to the transmission information;
a transmission information analyzing process for analyzing, at the receiving side, the transmission information transmitted by the transmitter to obtain the analyzed transmission information; and
an additional information analyzing process for analyzing the response type specifying whether the receiver is requested to answer by normal response or automatic response and the communication type specifying one of one-way communication and two-way communication, which are added to the analyzed transmission information, to obtain analyzed additional information added to the analyzed transmission information.

3. The method for a voice over IP telephone according to claim 1, characterized in that a door phone function is implemented by carrying out the voice over IP telephone process.

4. The method for a voice over IP telephone according to claim 1, characterized in that a recording/reproducing function is implemented by carrying out the voice over IP telephone process in an application server which is connected to the Internet and provides a service function.

5. The method for a voice over IP telephone according to claim 1, characterized in that a paging function is implemented by carrying out the voice over IP telephone process in an application server which is connected to the Internet and provides a service function.

6. An apparatus for a voice over IP telephone including voice over IP telephone means for carrying out voice communication adapted to an Internet Protocol through Internet,
characterized in that the voice over IP telephone means comprises transmission/additional information generating and analyzing means for generating, at a transmitting side, additional information of service content to be added to transmission information related to a transmitter and a receiver as a destination, and for analyzing, at a receiving side, the additional information added to the transmission information transmitted by the transmitter to obtain the service content.

7. The apparatus for a voice over IP telephone according to claim 6,
characterized in that the transmission/additional information generating and analyzing means includes:
transmission information generating means for generating transmission information related to the transmitter and the receiver as a destination;
additional information generating means for generating additional information so as to include a response type specifying whether the receiver as a destination is requested to answer by normal response or automatic response and a communication type specifying one of one-way communication and two-way communication and be added to the transmission information;
transmission information analyzing means for, at the receiving side, analyzing the transmission information transmitted by the transmitter to obtain the analyzed transmission information; and
additional information analyzing means for analyzing the response type specifying whether the receiver is requested to answer by normal response or automatic response and the communication type specifying one of one-way communication and two-way communication, which are added to the analyzed transmission information, to obtain analyzed additional information added to the analyzed transmission information.

8. The apparatus for a voice over IP telephone according to claim 6, characterized in that a door phone function is implemented by carrying out the voice over IP telephone means.

9. The apparatus for a voice over IP telephone according to claim 6, characterized in that a recording/reproducing function is implemented by carrying out the voice over IP telephone means in an application server which is connected to the Internet and provides a service function.

10. The apparatus for a voice over IP telephone according to claim 6, characterized in that a paging function is implemented by carrying out the voice over IP telephone means in an application server which is connected to the Internet and provides a service function.
